(19) United States
(12) Patent Application Publication
(10) Pub. No.: US 2025/0148253 A1
(43) Pub. Date: May 8, 2025

(54) TAGS PROVIDED WITH NEAR FIELD COMMUNICATION (NFC) CHIPS AND SENSORS

(71) Applicant: LINXENS HOLDING, Mantes la Jolie (FR)

(72) Inventors: Francois GERMAIN, Mantes la Jolie (FR); Simon VASSAL, Mantes la Jolie (FR)

(21) Appl. No.: 18/728,014

(22) PCT Filed: Feb. 9, 2023
(86) PCT No.: PCT/IB2023/000032

§ 371 Date: Jul. 10, 2024

(30) Foreign Application Priority Data
Feb. 23, 2022 (EP) 22305200.2

(51) Int. Cl. G06K 19/077; G06K 19/07

(52) U.S. Cl. CPC G06K 19/07718; G06K 19/0716; G06K 19/0723; G06K 19/07747; G06K 19/0775

(57) ABSTRACT

The present invention refers to a method for producing an integrated circuit comprising a Near Field Communication (NFC) chip, a sensor and an antenna, wherein the method comprises the steps of providing an intermediate circuit comprising the NFC chip connected the sensor, for instance a biosensor, and of providing a single side inlay comprising a substrate and the antenna. Afterwards, the intermediate circuit and the single side inlay are mated together so as to connect the NFC chip to the antenna. The present invention also refers to the integrated circuit or tag produced according to this method.

### RELATED APPLICATIONS

This application claims priority to International Application No. PCT/IB2023/000032, filed Feb. 9, 2023, which claims priority to EP Application Serial No. 22305200.2, filed Feb. 23, 2022, the contents of which are incorporated by reference herein in their entireties.

### TECHNICAL FIELD

The present invention generally relates to the field of tags comprising Near Field Communication (NFC) chips provided with sensors for communication with an external device. In particular, the NFC chips may be provided with biosensors for the application in the field of healthcare.

### BACKGROUND ART

Tags provided with Near Field Communication (NFC) chips, sensors and antennas are commonly employed for communicating with smartphones. The smartphone is able to retrieve, in a contactless way, the values measured by the sensor that is added to the NFC chip and to handle this information. For example, the NFC chips may be provided with biosensors for handling information regarding the healthcare of the smartphone's owner and the smartphone may be use for geolocation purposes.

It is known to the state of the art to produce the NFC chip, the sensor, and the antenna on a single integrated circuit. For example, a PET substrate covered with copper on both sides may be employed; the PET substrate may be etched to form the sensor electrodes and the antenna, and the electronic components may be then electrically connected to each other. The PET substrates that are typically employed may have dimensions of 70 mm×25 mm. Due to the large size of the final circuit, a large amount of copper is typically used for forming the antenna and the sensor. The resulting assembly process is hence expensive and time-consuming.

Accordingly, there is a need to optimize the assembly process of the circuit comprising the NFC chip, the sensor and the antenna in terms of time and costs.

### DISCLOSURE OF INVENTION

In view of the problems described above, the present invention is based on the idea of providing a method for producing an integrated circuit or tag comprising a NFC chip, a sensor and an antenna, wherein the active components (i.e. the NFC chip and the sensor) are separated from the antenna, in such a way that the surface of the antenna and/or the sensor can be reduce to the minimum and production costs can be optimized. The present invention also refers to the corresponding integrated circuit or tag.

According to a first aspect of the present invention, a method for producing an integrated circuit comprising a NFC chip, a sensor and an antenna is provided. The method comprises the following steps:
a) Providing an intermediate circuit comprising the NFC chip and the sensor, for instance a biosensor, wherein the NFC chip and the sensor are connected together;
b) Providing a single side inlay comprising a substrate and the antenna;
c) Afterwards, mating the intermediate circuit and the single side inlay so as to connect the NFC chip to the antenna.

The advantage of this method is that time and production costs are reduced and optimized.

According to an illustrative embodiment of the present invention, the sensor may be a biosensor for application in the field of healthcare. For instance, the biosensor may be an electro-chemical biosensor or a pressure sensor. For example, the electro-chemical biosensor may be used to measure a body secretion sample, such as blood, milk, mucus or the like. The sensor may accordingly generate an output signal based on the measured predefined properties of the sample and may transfer the output signal to the NFC chip. The NFC chip may process the output signal of the sensor and transmit another output signal to an external reader, for instance a smart phone. During operation, the integrated circuit is powered in the NFC range by the external reader; in particular, the electro-magnetic field generated by the external reader is retrieved by the antenna on the single sided inlay and is then converted in power by the NFC chip, so that the NFC chip and the sensor are accordingly powered. In this way, there is no need to add active batteries to the integrated circuit, hence the production costs may be reduced.

The smart phone may be used to process the data. For instance, the smart phone may be used for geolocation purposes. For instance, the smartphone may be connected to the cloud and the data may be transferred to a healthcare center and may be used to adapt a treatment for the smartphone's owner.

According to a preferred embodiment of the present invention, the active components of the integrated circuit, i.e. the NFC chip and the sensor, may be initially assembled together to form an intermediate circuit having a conductive coating only on one side. For instance, the conductive coating may comprise a copper coating.

At the same time, a single side inlay comprising a substrate and an antenna may be formed. For instance, the single side inlay may be an aluminum inlay or a wire-embedding inlay. Herein, it has to be understood that the single side inlay is a type of inlay that has the conductive components, such as copper and/or aluminum components, mounted only on one side of the inlay. In this way, production costs are reduced. In fact, for example, in a configuration comprising a wire-embedding antenna, the copper material may be used only for forming the wire of the antenna. In a configuration comprising an etched antenna, for example, the etched antenna may be formed on an aluminum inlay, wherein aluminum is a cheaper material compared to copper.

Finally, the intermediate circuit and the single side inlay may be mated together and the intermediate circuit may be connected to the antenna by means of connection pads. In this way, the antenna and NFC chip are electrically connected through the intermediate circuit. For instance, the antenna may be further provided with connection pads for connection to intermediate circuit and hence to the NFC chip. Alternatively, the antenna may be inductively coupled to a second antenna formed in the intermediate circuit.

According to a preferred embodiment of the present invention, a method may be provided, wherein the intermediate circuit comprises a single side construction.

Herein, it has to be understood that a single side construction indicates a circuit that has the conductive components, such as copper, mounted on one side, whereas no metallic components are formed on the other side. The advantage of this configuration is that the intermediate circuit has the conductive copper for forming the electrodes of the sensor, the electrical link to the NFC chip pads and the NFC chip pads only on one side, therefore, production costs are further reduced.

According to a preferred embodiment of the present invention, a method may be provided, wherein the antenna is connected to the intermediate circuit by means of direct soldering.

The advantage of this solution is that the electrical connection between the antenna and the intermediate circuit is cost effective because a low amount of copper material is employed.

According to a preferred embodiment of the present invention, a method may be provided, wherein the antenna is connected to the intermediate circuit by means of conductive glue.

The advantage of this solution is that the electrical connection between the antenna and the intermediate circuit is cost effective because a low amount of copper material is employed.

According to an alternative preferred embodiment of the present invention, a method may be provided, wherein the intermediate circuit comprises a double side construction and the antenna is inductively coupled to the intermediate circuit.

The advantage of this solution is that the output signal measured by the sensor and transferred by the sensor to the NFC chip may be further transferred to the antenna in a contactless way.

According to a preferred embodiment of the present invention, a method is provided, wherein the antenna comprises an etched antenna.

The advantage of this solution is that the antenna is formed in a simple and cost effective way, because a small amount of material is used thanks to the single sided construction.

Preferably, the etched antenna may be formed on a cost effective material like an aluminum inlay. Alternatively, the etched antenna may be formed on a copper inlay.

According to a preferred embodiment of the present invention, a method is provided, wherein the antenna comprises a wire-embedding antenna.

The advantage of this solution is that the amount of conductive material necessary for forming the antenna may be reduced, because the conductive material may be used only for forming the wire of the antenna. Preferably, the wire-embedding antenna is further provided with connection pads for connection to the NFC chip through the intermediate circuit.

According to a preferred embodiment of the present invention, a method may be provided, wherein the intermediate circuit further comprises a sensor substrate and the NFC chip is connected to the sensor substrate by means of a flip-chip technology.

Flip chip bonding can offer a number of advantages over other interconnection processes. Due to the short interconnections paths, compared to wire bonds, the speed of a device can be improved. In addition, as wire bonds loops are removed it provides a smaller form factor. Moreover, production costs are reduced with respect to wire-bonding technology, because no gold wires are required in a flip-chip assembly process.

In a flip-chip assembly process, the NFC chip is attached bond pad side down to a substrate or carrier of the sensor. The electrical connection is made by means of a conductive bump on the bond pad of the NFC chip. Once the NFC chip is connected, the stand-off distance between the chip and the sensor substrate is typically filled with a non-conductive adhesive or with an anisotropic conductive paste (ACP), referred to as underfill. The underfill provides stress relief between the chip and the sensor substrate, provides robustness, and protects the component from any moisture ingress.

According to a preferred embodiment of the present invention, a method may be provided, wherein the intermediate circuit has a width of 19 mm and a length of 35 mm.

The advantage of this solution is that the intermediate circuit has small dimensions, therefore the amount of copper employed for realizing the electronic components is reduced and production costs may be optimized. Moreover, since the intermediate circuits have small dimensions, a large number of intermediate circuits can be formed on the same reel. In this way, the flip-chip assembly process may be further optimized by assembling a plurality of chips at the same time, because there is no need to displace the reel on a large distance during a reel-to-reel assembly process.

According to a preferred embodiment of the present invention, a method is provided wherein the method is carried out by means of a reel-to-reel process.

The advantage of this solution is that the reel-to-reel process is a fast and efficient way for producing electronic circuits.

Preferably, a first reel comprising a plurality of single side inlays is provided and is subsequently combined with a second reel comprising a plurality of intermediate circuits. Thanks to the reduction of the overall dimensions of the intermediate circuits, the second reel must travel small distances for assembling the intermediate circuits, therefore the process is speed up.

According to a further embodiment of the present invention, a method is provided, wherein the step b) is carried out by forming the single side inlay on a panel.

The advantage of this method is that it can be adapted to pre-existing equipment for the production of integrated circuits comprising a wire-embedding antenna, because the wire-embedding process is typically carried out in panel form.

Preferably, the antennas formed on the panel may be wire-embedding antennas.

According to a second aspect of the present invention, a kit of components is provided, wherein the kit comprises a first component including an intermediate circuit comprising a NFC chip and a sensor, and a second component including a single side inlay comprising a substrate and an antenna, characterized in that the two components are separate components.

The advantage of this configuration is that time and production costs are reduced and optimized. In fact, the first and the second components are designed as separate components; accordingly, they may be produced at the same time and they may be assembled only at a later stage. Moreover, the overall amount of conductive material, such as copper, necessary for producing the electronic components may be reduced, because the antenna inlay is configured as a single side inlay. For instance, the single side inlay may be an aluminum inlay or a wire-embedding inlay.

According to a preferred embodiment of the present invention, a kit is provided, wherein the first component is a reel comprising a plurality of intermediate circuits and/or the second component is a reel comprising a plurality of single side inlays.

The advantage of this process is that the first and second components may be subsequently assembled by means of a reel-to-reel process, which is time and cost effective. Preferably, both the first and the second components are formed on reels. According to an illustrative and not limiting embodiment, only the second component may comprise a reel comprising a plurality of single side inlays.

According to a preferred embodiment of the present invention, a kit is provided, wherein the antenna is a wire-embedding antenna and the second component is a panel comprising a plurality of single side inlays.

Preferably, the first and second components of the kit may be produced according to any of the methods described above.

As a third aspect of the present invention, an integrated circuit produced by one of the methods described above is provided.

The integrated circuit may be for instance a sensor tag.

As a fourth aspect of the present invention, a system comprising an integrated circuit, for instance a sensor tag, and an external reader may be provided. The external reader provides the necessary power to the antenna so that the NFC chip and then to the sensor can perform the electrical measurements on the sample and can generate a corresponding output signal. The external reader may be advantageously employed for receiving the output signal generated by the sensor via the NFC chip and the antenna and may be further used for processing and handling the signal. For instance, the external reader may comprise a smartphone.

### BRIEF DESCRIPTION OF THE DRAWINGS

The present invention will be described with reference to the attached figures in which the same reference numbers and/or signs indicate the same parts and/or similar and/or corresponding parts of the system.

FIG. 1A schematically illustrates a top view of an antenna single side inlay of a tag according to an embodiment of the present invention.

FIG. 1B schematically illustrates a top view of an intermediate circuit according to an embodiment of the present invention.

FIG. 2A schematically illustrates a top view of the contact side of a tag, according to the state of the art.

FIG. 2B schematically illustrates a top view of the antenna side of a tag according to the state of the art.

FIG. 3 schematically illustrates a side view of a tag according to an embodiment of the present invention.

FIG. 4 schematically illustrates a side view of a tag according to an alternative embodiment of the present invention.

### DETAILED DESCRIPTION

In the following, the present invention is described with reference to particular embodiments, as is illustrated in the enclosed figures. However, the present invention is not limited to the particular embodiments described in the following detailed description and shown in figures. Instead, the described embodiments simply exemplify the different features of the present invention, the scope of which is defined in the claims. Further modifications and variations of the present invention will be clear to the skilled person.

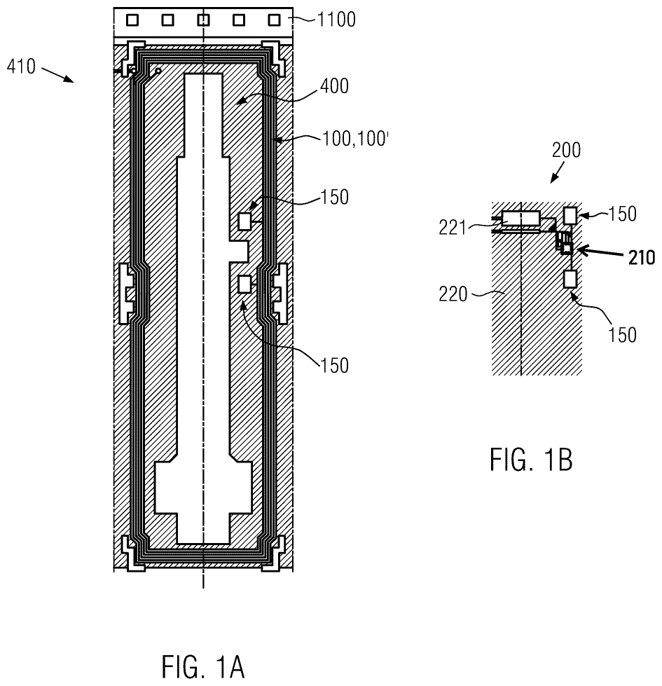

FIGS. 1a and 1b schematically illustrate the components of an integrated circuit or tag that can be produced with a method according to the present invention. In particular, FIG. 1A schematically illustrates a single sided inlay 410 comprising an antenna 100, 100′ according to an embodiment of the present invention. FIG. 1B schematically illustrates an intermediate circuit 200 according to an embodiment of the present invention. The single sided inlay 410 is connected to the intermediate circuit 200 via the connection pads 150.

The single side inlay 410 according to the present invention comprises a substrate 400 made of dielectric material, for instance PVC or PET. On the top side of the substrate 400, an antenna 100, 100′ is formed. For instance, the antenna may be an etched antenna 100 or a wire-embedding antenna 100′. The antenna 100, 100′ encircles a large area of the substrate 400, wherein the intermediate circuit 200 is placed and connected. The intermediate circuit 200 comprises a sensor electrode 221 and a NFC chip 210 that are mounted on and connected to a sensor substrate 220. The sensor substrate 220 is in turn connected to the antenna 100, 100′ via the connection pads 150. In this way, the NFC chip 210 and the antenna 100, 100′ are electrically connected.

The substrate 400 and the antenna 100, 100′ form a single side inlay 410, that is a type of inlay that has the conductive component, for instance conductive copper or aluminum, mounted only on one side, that is the side shown in FIG. 1A. The single side inlay 410 is preferably made on a reel, so that the final integrated circuit or tag can be formed by means of a reel-to-reel process. In FIG. 1a it is hence possible to see a part of the reel tape 1100 provided with holes.

Preferably, a reel tape may comprise a plurality of single side inlays 410. Accordingly, a plurality of tags 1000 may be formed on the same reel, after the single side inlays 410 are mated to the intermediate circuits 200 in a reel-to-reel process. Preferably, the intermediate circuits 200 may also be formed on a reel.

The antenna 100, 100′ is preferably provided with two connection pads 150 for electrically connecting the intermediate circuit 200, which is in turn provided with mating connection pads, as clearly visible in FIGS. 1a and 1b.

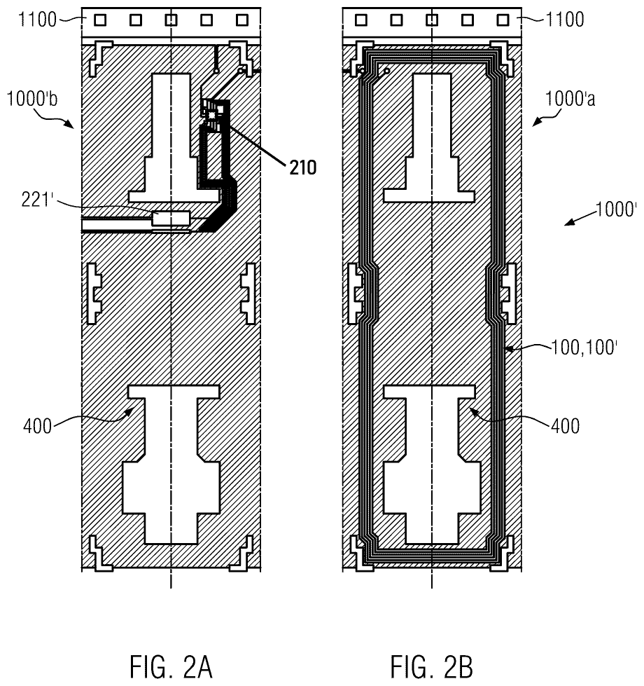

For comparison, FIGS. 2a and 2b schematically illustrate an integrated circuit or tag 1000′ according to the state of the art. In particular, FIG. 2a schematically illustrates the bottom side or contact side 1000′b of the tag 1000′ according to the state of the art. FIG. 2b schematically illustrates the top side or antenna side 1000′a of the tag 1000′ according to the state of the art.

The contact side 1000′b comprises a sensor 221′. The antenna side 1000′a comprises a dielectric substrate 400 and an antenna 100, 100′. The tag 1000′ according to the state of the art has hence a double side construction, wherein the electronic components are formed on both sides. In this way, a large amount of conductive material must be employed, thus increasing production costs. Moreover, according to the methods known to the state of the art, the sensor 210′, the NFC chip 210 and the antenna 100, 100′ are assembled together on a single circuit, thus requiring longer production times.

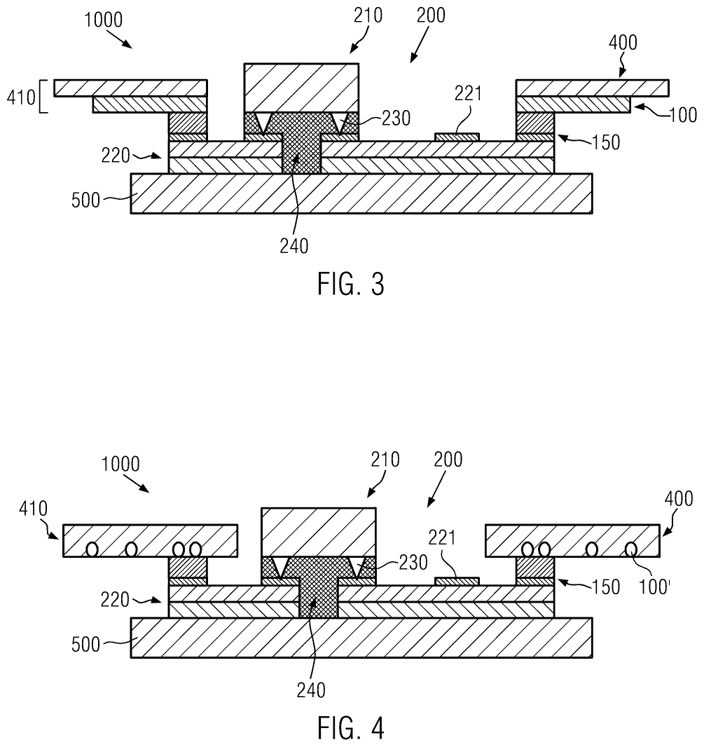

FIG. 3 schematically illustrates a side view of an integrated circuit or tag 1000 according to an embodiment of the present invention.

The tag 1000 comprises a NFC chip 210 and a sensor 221, such as an electrode sensor. For instance, the sensor 221 may be a biosensor for healthcare applications. For instance, the biosensor 221 may be an electro-chemical biosensor, which is configured to receive a bodily secretion specimen (for instance blood, mucus, milk or the like) and a reagent and to produce an output signal in response to the tested specimen. Alternatively, the sensor 221 may be a pressure sensor. Preferably, the NFC chip 210 has a thickness of 150 μm. Preferably, the sensor 221 has a thickness comprised between 12 μm and 70 μm.

The NFC chip 210 is connected to the sensor 221 and to a sensor substrate 220 so as to form an intermediate circuit 200. For instance, the NFC chip 210 may be connected to the substrate 220 by means of flip-chip technology. In this way, the electrodes 221 of the sensor are electrically connected to the chip 210. In a flip-chip assembly process, the NFC chip 210 is attached bond pad side down to a substrate or a carrier of the sensor 220. The electrical connection is made by means of conductive bumps 230 on the bond pads of the NFC chip 210. Once the NFC chip 210 is connected, the standoff distance between the chip 210 and the sensor substrate 220 is filled with an adhesive material 240, also known as underfill. For instance, the adhesive material may comprise a non-conductive adhesive or an anisotropic conductive paste. The adhesive material 240 provides stress relief between the NFC chip 210 and the sensor 221, provides robustness and protects the components from any moisture ingress. For example, the conductive bumps 230 may have a thickness of 20 μm and the adhesive material 240 may have a thickness of 20 μm.

According to alternative embodiments, the NFC chip 210 and the sensor 221 may be connected by means of wire-bonding technology.

The intermediate circuit 200 may have, for instance, a size of 19×35 mm. After assembly, the intermediate circuit 200 is mated to the single side inlay 410 comprising the dielectric substrate 400 and the antenna 100. In other words, the intermediate circuit 200 and the single side inlay 410 are formed as separate components and they are subsequently assembled to form the integrated circuit or tag 1000. In this way, the assembly process is carried out in a faster, cheaper and more efficient way. Preferably, the single side inlays 410 and the intermediate circuits 200 are formed on two separate reels and are subsequently mated by means of a reel-to-reel process so as to form the integrated circuits or tags 1000.

The antenna 100 illustrated in FIG. 3 is an etched antenna, which may be formed on an aluminum inlay. In fact, aluminum is a cost effective material.

A substrate 500 may be further mated to the tag 1000, in order to cover and protect the sensor 221 from the external environment. The substrate 500 may be made of plastic, for instance PET, PI or Epoxy Glass.

FIG. 4 schematically illustrates a side view of an integrated circuit or tag 1000 according to an alternative embodiment of the present invention. The tag 1000 of FIG. 4 comprises an intermediate circuit 200 and a single side inlay 410 that are assembled together after being formed as independent components, as described with reference to FIG. 3. The single side inlay 410 of FIG. 4 differs from the single side inlay 410 of FIG. 3 in that it comprises a substrate material 400 with a wire-embedding antenna 100′. Preferably, the wire-embedding antenna 100′ is made of copper. The copper material is used only for the formation of the wire of the antenna; therefore, production costs are reduced.

The intermediate circuit 200 is preferably configured as a single side component, in order to further reduce production costs. According to alternative embodiments, the intermediate circuit 200 may be configured as a double side component and the NFC chip 210 may be further provided with an antenna for inductive coupling with the booster antenna 100, 100′. Preferably, the double-sided intermediate circuit 200 is coupled to a large booster antenna 100′, which is produced by wire embedding.

The intermediate circuit 200 comprising the NFC chip 210 powered by the antenna 100, 100′ may be used for direct communication with an external device, such as a smart phone. The external device may be advantageously employed for powering the integrated circuit 200. In this way, the output signal measured by the sensor 221 may be transferred to the external device thanks to the NFC chip 210 powered by the antenna 100, 100′. The smart phone may be used for handling the data measured and transmitted by the tag 1000. For instance, the smart phone may be used for geolocation purposes. For instance, if the tag 1000 provided with the biosensor 221 is used for measuring an infection signal starting from a bodily secretion specimen, the infection signal may be transferred to the smart phone and, thanks to the geolocation function of the smart phone, the whole system may be used to control the spread of an infection.

Even if the present invention has been described with reference to the embodiments described above, it is clear to the skilled person that it is possible to apply different modifications, variations and improvements of the present invention in light of the teachings described above and the field, and within the scope of the enclosed claims, without departing from the scope and purpose of the present invention.

Finally, those fields considered known to the skilled person have not been described to avoid covering in a useless way the described invention.

For instance, the flip-chip technology and the wire-bonding technology have not been described in detail, because they are considered to be known to the skilled person. For instance, the reel-to-reel process has not been described in detail, because it is supposed to be known to the skilled person. For instance, the Near Field Communication technology has not been described in detail, because it is supposed to be known to the skilled person.

### REFERENCE NUMBERS

100, 100′: antenna
150: connection pads
200: intermediate circuit
210: NFC chip
220: sensor substrate
221: sensor
230: bump material
240: underfill material
400: antenna substrate
410: single side inlay
500: tag substrate
1000: tag
1000′: tag according to state of the art

1. A method for producing an integrated circuit comprising a Near Field Communication (NFC) chip, a sensor and an antenna, said method comprising the following steps:
a) Providing an intermediate circuit comprising said NFC chip and said sensor, for instance a biosensor, wherein said NFC chip and said sensor are connected together;
b) Providing a single side inlay comprising a substrate and said antenna;
c) Afterwards, mating said intermediate circuit and said single side inlay so as to connect said NFC chip to said antenna.

2. The method according to claim 1, wherein said intermediate circuit comprises a single side construction.

3. The method according to claim 1, wherein said antenna is connected to said intermediate circuit by direct soldering.

4. The method according to claim 1, wherein said antenna is connected to said intermediate circuit by conductive glue.

5. The method according to claim 1, wherein said intermediate circuit comprises a double side construction and said antenna is inductively coupled to said intermediate circuit.

6. The method according to claim 1, wherein said antenna comprises an etched antenna.

7. The method according to claim 1, wherein said antenna comprises a wire-embedded antenna.

8. The method according to claim 1, wherein said intermediate circuit further comprises a sensor substrate and said NFC chip is connected to said sensor substrate by flip-chip technology.

9. The method according to claim 1, wherein said intermediate circuit has a width (W) of 19 mm and a length (L) of 35 mm.

10. The method according to claim 1, wherein said method is carried out by a reel-to-reel process.

11. The method according to claim 7, wherein said step b) is carried out by forming said single side inlay on a panel.

12. A kit of components comprising:
a first component including an intermediate circuit comprising a Near Field Communication (NFC) chip and a sensor, and
a second component including a single side inlay comprising a substrate and an antenna;
wherein said first component and said second component are separate components.

13. The kit of components according to claim 12, wherein said first component is a reel comprising a plurality of intermediate circuits and/or said second component is a reel comprising a plurality of single side inlays.

14. The kit of components according to claim 13, wherein said antenna is a wire-embedded antenna and said second component is a panel comprising a plurality of single side inlays.

15. The integrated circuit produced by the method comprising the following steps:
a) Providing an intermediate circuit comprising a Near Field Communication (NFC) chip and a sensor, for instance a biosensor, wherein said NFC chip and said sensor are connected together;
b) Providing a single side inlay comprising a substrate and an antenna;
c) Afterwards, mating said intermediate circuit and said single side inlay so as to connect said NFC chip to said antenna.

16. The integrated circuit according to claim 15, wherein said intermediate circuit comprises a single side construction.

17. The integrated circuit according to claim 15, wherein said antenna is connected to said intermediate circuit by direct soldering.

18. The integrated circuit according to claim 15, wherein said antenna is connected to said intermediate circuit by conductive glue.

19. The integrated circuit according to claim 15, wherein said intermediate circuit comprises a double side construction and said antenna is inductively coupled to said intermediate circuit

20. The integrated circuit according to claim 15, wherein said antenna comprises an etched antenna.
